(19) United States
(12) Patent Application Publication
(10) Pub. No.: US 2015/0286652 A1
(43) Pub. Date: Oct. 8, 2015

(54) METHOD AND SYSTEM FOR FILTERING AND ACTIONING OF ENERGY MANAGEMENT EVENTS

(71) Applicant: AssetWorks LLC, Wayne, PA (US)

(72) Inventors: Kevin Charles, Austin, TX (US); William T. Drake, Austin, TX (US)

(21) Appl. No.: 14/680,698

(22) Filed: Apr. 7, 2015

Related U.S. Application Data
(60) Provisional application No. 61/975,953, filed on Apr. 7, 2014.

(51) Int. Cl. G06F 17/30; G05B 15/02; G06Q 50/06

(52) U.S. Cl. CPC G06F 17/30156; G06Q 50/06; G05B 15/02

(57) ABSTRACT

A method and system for filtering and actioning of events, such as energy management events, received from an event generating system, and actioning the events that are not filtered using generators used by a facilities management system. One aspect includes a method for energy management event filtering comprising: receiving, by an event handler controller of a facilities management system, an unfiltered stream of energy management events from an energy management system, where each energy management event relates to violation of a unique rule in the energy management system; and determining, for each energy management event, whether there is an event handler configuration for the rule relating to the energy management event.

### CROSS-REFERENCE TO RELATED APPLICATIONS

This application claims the benefit of U.S. Provisional Application Ser. No. 61/975,953 filed Apr. 7, 2014, entitled “METHOD AND SYSTEM FOR FILTERING AND ACTIONING OF ENERGY MANAGEMENT EVENTS,” which is incorporated herein by reference in its entirety.

### BACKGROUND

1. Field

The present invention relates generally to filtering and actioning events from an event generation system, and more particularly, where the events relate to energy management at one or more facilities.

2. Description of Related Art

Event generation systems exist, as do facilities management systems. However, such systems operate independently and do not allow for efficient and helpful combination. In particular, external event generation systems are good at identifying equipment problems/inefficiencies, but do nothing to resolve the issue. Secondly, external event generation systems are noisy by nature, generating a large volume of events that need to be evaluated prior to dispatching expensive repair resources and requiring significant operator interaction. Thirdly, the response to event generation systems is not a one size fits all, hence the response must be highly flexible so a specific business process can be assigned to each event “type”.

There is thus a need for filtering and actioning of energy management events.

### SUMMARY

One aspect described herein is directed to a method for energy management event filtering comprising: receiving, by an event handler controller of a facilities management system, an unfiltered stream of energy management events from an energy management system, where each energy management event relates to violation of a unique rule in the energy management system; and determining, for each energy management event, whether there is an event handler configuration for the rule relating to the energy management event.

If there is an event handler configuration for the rule relating to the energy management event then: the event handler controller may apply one or more coarse event filters in the event handler configuration to the energy management event to determine whether to filter out the energy management event. The event handler controller may also combine the occurrences of the energy management event to determine whether to filter out the energy management event. The event handler may also de-duplicate the energy management event to determine whether to filter out the energy management event. A generator may actioning the energy management event if it has not been filtered out.

Another aspect described herein may comprise ignoring or filtering out the energy management event if there is no event handler configuration. Yet another aspect described herein may comprise ignoring or filtering out the energy management event if the event's asset is on a list of assets to filter out where the list of assets may be established dynamically by applying criteria to a list of total available assets.

The combining may comprise assembling the number occurrences of an energy management event and the duration of each occurrence to determine a total impact to make the determining.

A scripting engine may be provided with the energy management event and apply a script if a script is specified for the event. The scripting engine may receive all events except those that are filtered out by the applying. The event may comprise event data and event metadata, the event metadata comprising a flag for each generator, and wherein the combining and de-duplicating set the metadata flag. The de-duplicating may comprise de-duplicating events that would lead to duplicate actioning or steps by one or more generators. The actioning may comprise one or more of displaying the energy management event, sending the energy management event for processing in a script, sending the energy management event in a message, creating a work order from the energy management event, or creating a customer request from the energy management event.

### BRIEF DESCRIPTION OF THE DRAWINGS

Embodiments will now be described, by way of example only, with reference to the attached Figures, wherein:

FIG. 1 shows a system for energy management event filtering according to an embodiment of the invention;

FIG. 2 shows a number of components of a system for energy management event filtering according to an embodiment of the invention;

FIG. 3 shows a further number of components of a system for energy management event filtering according to an embodiment of the invention;

FIG. 4 shows a method for energy management event filtering according to an embodiment of the invention; and

FIGS. 5-8 show screens for energy management event filtering according to an embodiment of the invention.

### DETAILED DESCRIPTION

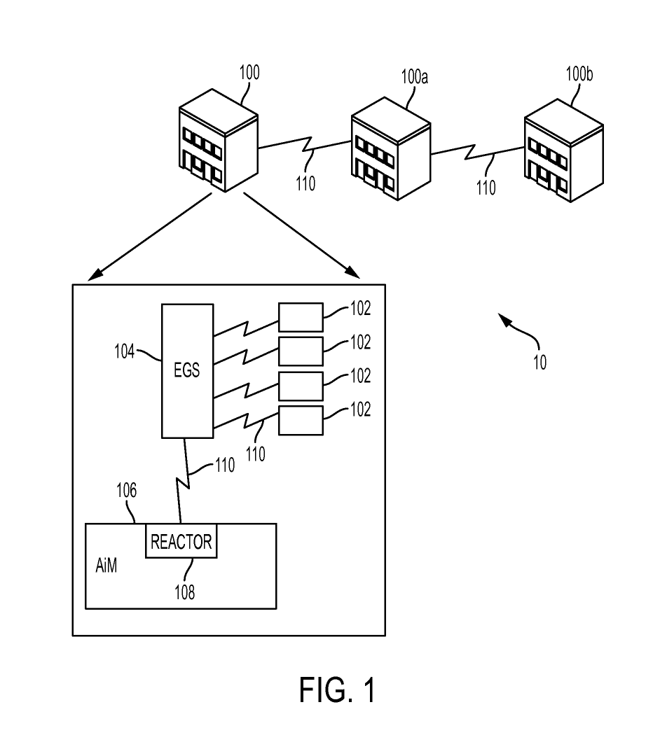

FIG. 1 shows a system for energy management event filtering comprising one of facilities 100/100a/100b, each of which may further comprise assets 102 and may further comprise or be in communication with (via one or more communication networks 110) event generating system (EGS) 104, facilities management system (FMS) 106 which may further comprise reactor 108.

Facilities 100 may comprise one or more buildings or large structures that may be interconnected or jointly owned (such as if facility 100, facility 100a and facility 100b were three buildings in an academic department of a university). Exemplary facilities may include collections of buildings belonging to a university, hospital, government agency, commercial real estate firms or management firms, and the like.

Assets 102 may be any asset located at a facility 100, or related to or owned by a common owner as a facility 100. Exemplary assets 102 may include air conditioners, furnaces, HVAC equipment and related items, windows, equipment, machinery, vehicles, rooms within facility 100, resources (water, gas, generators, solar panels, etc), and substantially any item that may be of value and connected to, or measurable by, EGS 104.

EGS 104 may be substantially any event monitoring system that communicates, directly or indirectly, with assets 102 so as to monitor, and optionally control, assets 102. Exemplary EGS 104 may include AiMIQ™, BAS controls systems, and 3rd party endpoints that speak the Haystack protocol (or other similar such protocols). In monitoring and/or controlling assets 102, EGS 104 creates a stream of energy management events, relating to the energy use or data from assets 102 that may be sent to other systems, such as facilities management system 106.

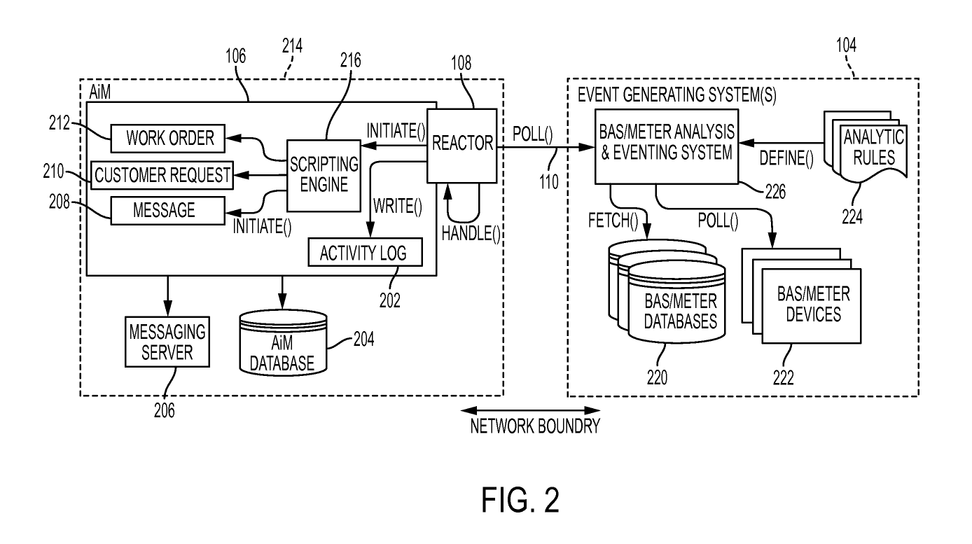

As shown in FIG. 2, EGS 104 further comprises analytic rules 224, BAS/Meter devices 222 and BAS/Meter databases 220 and BAS/Meter Analysis & Eventing System (ES) 226. These aspects of EGS 104 allow, for example:
rules to be created and stored, and events can occur as a result of rule violations;
BAS/Meter devices to be communicated with (such as by polling or having information pushed to ES 226); and
BAS/Meter information and data to be stored in databases (such as BAS/Meter databases 220).

In general, an event is an “instance ” of a given occurrence generated by some external eventing, or event generation system; e.g., a heating and cooling failure caused by a stuck damper, and may be comprised explicit and contextual data describing one or more occurrences. Events may have metadata to assist system 10 in determining whether to action or filter out the event. In one embodiment events may have a metadata flag for each of the generators that are enabled in system 10; for example if a generators flag is set to true then such generation may action the event (and de-duper, combiner or scripting engine 442 may set or clear various metadata flags). As used herein, an Event Handler is a pre-configured response to a given event type; e.g., a “handler” configured to explicitly deal with the stuck damper. The handler is configurable such that the reactor can process (“react”) to n events. The critical information contained in the event may include the rule identifier that was violated, the associated asset(s) 102, occurrences (such as the number, duration and severity), and duration for the requested look back window (e.g. how far in the past to look for the same or similar incidents). Additional contextual data may be required by the Event Handler and associated downstream processes or systems. An energy management event may be a particular type of event that may indicate improper or inefficient use of energy by one or more assets 102 or facilities 100. Both events and energy management events may be defined by data structures (static or dynamic) that encompass data to properly describe the event (and that may allow other systems to action the received energy management event). A stream of energy management events is therefore a succession of energy management events (or events and energy management events, depending on what events are to be sent to, for example, facilities management system 106), that may or may not be related, may be comingled or kept separately in transmission, and may or may not relate to the same asset 102, facility 106 or combination thereof. In general, once EGS 104 has been configured, the events or streams thereof that are sent by EGS 104 is static, though EGS 104 may of course be tunable. EGS 104 is often, in practice, configured to liberally send energy management events (and events in general) so that “nothing is missed” but distractions are increased.

Communication network 110 may be substantially any public or private network, wired or wireless, and may be substantially comprised of one or more networks that may be able to facilitate communication between themselves. Communication network 110 may facilitate various types of communication, such as cellular, WiFi, and the like.

FMS 106 is a system for facilities use, monitoring and management and may help organizations reduce costs by promoting better oversight and utilization of facilities and real estate, eliminate management redundancies and proactively manage the workplace, ensure regulatory and—social compliance by providing auditable data and complete transparency to enterprise assets (such as assets 102), and realize their sustainability and business continuity goals. Exemplary FMS include AiM™ by AssetWorks.

FMS 106 further comprises reactor 108, which may also be referred to as event handler 108. Event handler 108 receives events, or a stream of events, from EGS 104 and determines whether the event (such as energy management event) should be filtered out or not. Event handler 108, upon determining that an event should not be filtered out, may action the event (as described herein) by enabling or causing one or more actions to occur as a result of the event not being filtered out. As described herein, event handler may apply one or more methodologies to determine whether to filter out an event, such as filtering (coarse or fine), assessments of combinations, de-duplicating, and the like. As described herein, event handler may action an event that is not filtered out by running one or more customer scripts against the event (which may cause the event to then be filtered out), create a custom email to deliver to one or more recipients informing them of the event (possibly based on a template that can be filled in with data from an energy management event data type or data parameters), create a statement of work for one or more assets 102 (automatically or with user approval/review), or create a customer request (for example by populating a template).

Event handler 108 may have one or more flags that map to one or more of the filtering available. Such flags may allow filtering to be turned on and off according to the nature of the event, operator preferences, and the like. As such many filters may be included and selectively turned on and off.

As shown in FIG. 2, FMS 106 may further comprise one or more generators (such as work order generator 212, customer request generator 210 and message generator 208) that may “action” events, such as energy management events that are not filtered out as being “noise”. Generators may be part of FMS 106, reactor 108 or independent therefrom. Generators may be added or removed according to the preferences of the owner of the facility or operator of FMS 106 Further, as the functionality of FMS 106 is expanded additional generators may be developed and used. In particular, with respect to the generators shown in FIG. 2:

Work Order Generator 212 210 ingests an event or details about the event (generally that has not been filtered out) from one or more of reactor 108 or scripting engine 216 to create a work order. Work orders may include replacing a part on an air conditioning unit, checking a lighting system schedule because lights are on and site is unoccupied, checking a damper that is stuck open, replacing a valve, and the like.

The event's asset (that is, the asset or assets that relate to the event being considered) is used to pre-populate the Work Order's Region/Facility/Property/Location. Work Order defaulting logic may be applied by FMS 106 (such that FMS 106 or generators may continue with work orders, as they would in normal operation without a generator, based on the parameters provided by the generator). The event's rule may define all required Work Order/Phase fields in Camel Case form. e.g., problemCode, aePProEStatusCode, aePPhsEStatusCode. No duplicate logic check other than the default provided by FMS 106 or reactor 108. Any errors encountered may be written to the Activity Log 202. Generated Work Orders can be linked back to event handler 108 using the Work Order's reactor_tranx_num field, which is in both the work order and the energy management event (such as customer request) and is the ID of the handler record that created the work order/customer request. The reactor_tranx_num may be saved (or a link to it may be saved) for use later in FMS 106 reports that can show the request and which thresholds the event exceeded that caused the generation.

Customer Request Generator (CGR) 210 ingests an event or details about the event (generally that has not been filtered out) from one or more of reactor 108 or scripting engine 216 to create a customer request. Customer requests may include recommended actions on how to fix the problem, the priority of the request, asset, region, and the like as described herein.

CGR 210 may use the event's asset and information to pre-populate the Customer Request's Region/Facility/Property/Location of a customer request. All Customer Request defaulting logic may be applied by FMS 106 (such that FMS 106 or generators may continue with customer requests, as they would in normal operation without a generator, based on the parameters provided by the generator). The event's rule may define all required Customer Request fields in Camel Case form, for example problemCode, aePReqEStatusCode, aePReqEDescription. Use of Camel Case may be to conform to other parts of system 10, reduce difficulties based on names with spaces and the need to “escape” when the data is moved over protocol, and may also simply be a standard practice. Any errors encountered may be written to the Activity Log.

Duplication logic may be applied, for example, only if the Event Handler configuration “skip duplicate flag” field is set to ‘N’. A Customer Request may considered a duplicate if it has the same reactor transaction number, the request is in a non-complete status, and contains the same asset. Duplicate customer requests may be ignored and may be logged in the activity log.

Message Generator 208 ingests an event or details about the event (generally that has not been filtered out) from one or more of reactor 108 or scripting engine 216 to create a message, for example that may be sent to user of FMS 106, external departments of the facility owner, third party suppliers that may be implicated by the event, and the like. Communication may be via email (to one or more email addresses, where different events/rules may lead to email messages to different email addresses), SMS, RSS feed, and the like. Messages may include any form of, or reason for, communication with one or more users or stakeholders of system 10. Messages can include any information stored in a handler such as duration and occurrence thresholds, from which system (EGS or other system type such as HVAC, or other systems of a building or site) the event came from and any contextual information specified in the event's rule being processed, such as, actual duration and occurrences of the event. Message generator 208 may interact with messaging server 206 to actually communicate the message (where messaging server 206 may be an email server such as a Microsoft Exchange™ server or the like).

The event's rule may define attributes (optional or mandatory) that can be accessed using an email template, where mandatory attributes or fields may be required to create the action (message, customer request, etc). Any errors encountered may be written to the Activity Log. Duplicate messages may be prevented. A message is considered a duplicate if it has the same reactor transaction number, event date, and specifies the same asset.

An email template (or more generally a message template) may be used to format a message. The email template has access to the Reactor Connection, Event Notification, and any attributes contained in the Event's rule. Message templates provide a customization scheme for defining the content contained within a message initiated by Reactor 108 or scripting engine 216. The template may use the email template syntax of FMS 106 or have its own. All fields defined in the Connection Manager and Event Notification Handler database tables may be included in the templates. By way of example, message/email templates may include all rule attributes, HTML anchor link (“href”) to the specific initiating Reactor Event Handler, and when available, the HTML anchor link (“href”) to the external Event origin contained within the Event Generating System. The tables below contain examples for injecting or inserting the values into the email template. FMS 106 may already have a proprietary notation for handling email templates, (such as “/*field name containing the information*/”, as below). The tables below shows how to access the fields when creating an email template. The left column is just the “more accessible” name of the actual value on the right. Table 1 shows how to access the configuration and handler data. Table 2 contains how to access the information specified in the event's rule. Note that the values can change depending on how the rule was setup by the user. Table 3 gives access to url links that can be included in the email to take you FMS 106 screens (to view and interact with the event and/or action and reactor 108) and if available to the external event being processed. Further field examples may include:

TABLE 1
Accessing Table Values

| | |
|---|---|
| Reactor Id | /*ae_s_fs_action.tranx_num*/ |
| Rule Id | /*ae_s_fs_action.rule_id*/ |
| Connection Id | /*ae_s_fs_config.tranx_num*/ |
| Connection Url | /*ae_s_fs_config.url*/ |

TABLE 2
Accessing Rule Values

| | |
|---|---|
| Event Date | /*eventDate*/ |
| Duration | /*duration*/ |
| Occurrences | /*occurrences*/ |
| Help | /*help*/ |
| Problem Code | /*problemCode*/ |

TABLE 3
Accessing Predefined Values

| | |
|---|---|
| Duration Exceeded By | /*durationExceeded*/ |
| Occurrences Exceeded By | /*occurrencesExceeded*/ |
| Reactor Link | /*reactorLink*/ |
| Event Link | /*eventLink*/ |

FMS 106 may further comprise activity log 202. Activity Log 202 may store a detailed history of all events, events that did not get filtered out, actions initiated by Reactor 108, actions performed by generators, errors encountered, and significant runtime messages. It may be used to validate/debug Reactor 108 behavior, aid in de-duplication logic and as a key data source for analysis. The following fields may be part of entries in activity log 202:

Activity Log (ae_s_fs_action_activity_log)
Sequence (err_seq): Primary Key and main identifier of the log entry
Entry Date (err_datetime): Date and time the entry was logged
Type (err_type): Type of message logged
   Action—represents a successful execution that created a Work Order, Customer Request, or called a Script
   Duplicate—A Customer Request or Message was found to be a duplicate
   Error—An error was found during processing, no emails nor records were created
   Email—Used when an email is sent successfully
Transaction (event_tranx_num): Id of the Event Handler involved
Event Type (event_type): Type of event being generated. Work Order, Customer Request, Message or Script
Event Date (event_date): This represents the date of the last event that occurred within the look back period
Connection (connection_id): Connection id involved in current action
Work Order (proposal): Id of Work Order created
Script (script_id): Field specifying the document id of the script involved
Asset Tag (asset_tag): Field specifying asset involved in action
Description (description): Field containing link to record created or found to be a duplicate
Reason (reason): Detail description of action taken. If an error was found during processing this field contains the description of the error.
Emails (emails): Comma separated list of emails used to sent email
Event Id (rule_id): Id of an external analytic rule
Duration (duration): This is a copy of the duration field from the Event Handler used during processing
Occurrences (occurrences): This is a copy of the occurrences field from the Event Handler used during processing
Event Duration (event_duration): This is the total duration in hours of the events
Event Occurrences (event_occurrences): This is the total occurrences of the events

FMS 106 may also comprise FMS database 204. FMS database 204 may be a relational database for FMS 106, and may store data as required and by accessible via, for example FMS 106. FMS database 204 may store information relating to FMS 106 but also may store data from EGS 104, modified by reactor 108 (or scripting engine 216 or one or more generators) or unmodified.

FMS 106 may further comprise scripting engine 216. Scripting engine 216 may allow one or more template scripts or custom scripts to be developed that can be applied against one or more rules or events. The event's rule may define optional attributes that can be accessed by the script as described herein. Scripting engine 216 may receive all events that went through reactor 108 and were not filtered out, for example—which may provide an opportunity to customize or amend downstream handling, perform ad-hoc de-duping, and other relating filtering and processing. In processing events, scripting engine 216 may perform actioning, such as via one or more generators, edit/modify/delete an event (including an events metadata) and may return the revised event to event handler 108 (for possible further dissemination).

As indicated at 110, FMS 106 may, via reactor 108, poll EGS 104 for example to receive a stream of events or energy management events. Of course it is to be understood that such communication may be push or pull (ie polling by reactor 108 or pushed from EGS 104 via ES 226).

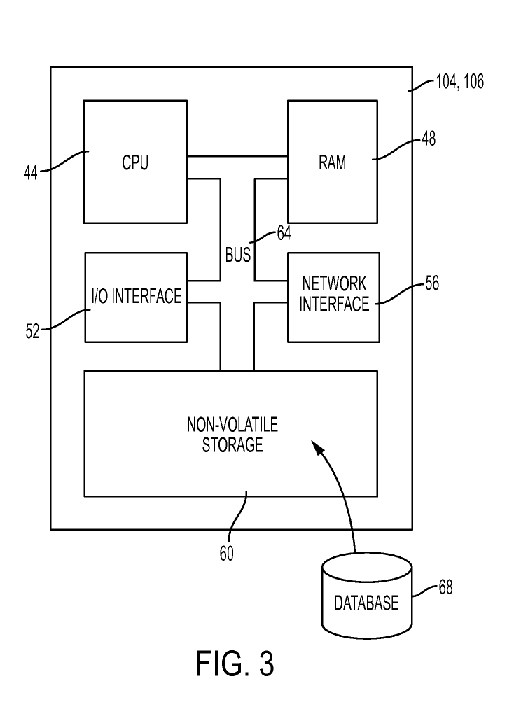

FIG. 3 shows a number of components of both EGS 104 and FMS 106. As shown, EGS 104 and FMS 106 have a number of components, including a central processing unit (“CPU”) 44 (also referred to simply as a “processor” or controller), random access memory (“RAM”) 48, an input/output interface 52, a network interface 56, non-volatile storage 60, accelerometer 70, and a local bus 64 enabling the CPU 44 to communicate with the other components. The CPU 44 executes an operating system and programs that provide the desired functionality. RAM 48 provides relatively-responsive volatile storage to the CPU 44. The input/output interface 52 allows for input to be received or provided from one or more devices, such as a keyboard, a mouse, a touchscreen, etc., and enables the CPU 44 to present output to a user via a monitor, a speaker, a screen, etc. The network interface 56 permits communication with other systems for communicating and receiving events, actioning events, and the like. Non-volatile storage 60 stores the operating system and programs, including computer-executable instructions for itinerary planning During operation of EGS 104 and FMS 106, the operating system, the programs and the data may be retrieved from the non-volatile storage 60 and placed in RAM 48 to facilitate execution.

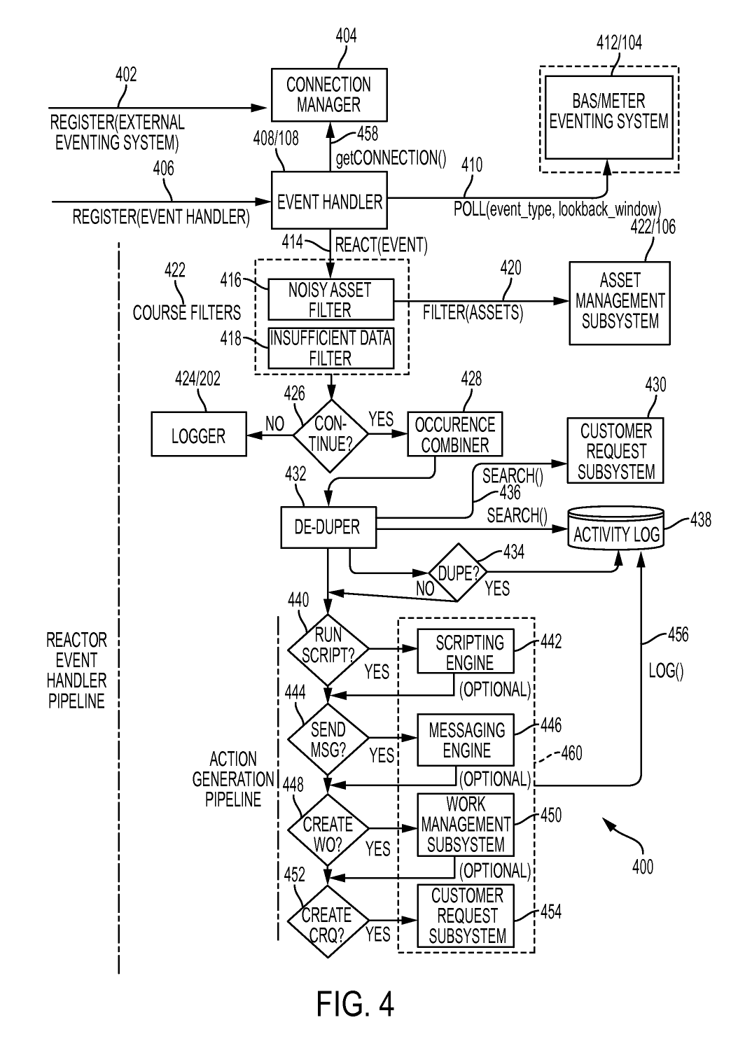

FIG. 4 shows a method 400 for energy management event filtering according to an embodiment of the invention.

Method 400 begins at 402 where connection manager 404 registers with one or more EGS 104. At 404, method 400 may define the protocol and authentication settings required for interaction with Event Generating Systems 104. At least one active connection configuration per deployment is generally required to enable communicate. If more than one EGS 104 is defined a sequence may be set to guarantee the order in which the systems are processed (ie which system to poll first, for example). Connection manager (ae_s_fs_config may be the name of the database table where values for the connection manager, and related screen, may be stored) may contain the following fields for each connection:
Transaction (tranx_num may be the name of the column in the table): This field is the primary key and main identifier of a unique connection.
Description (description): This is a typical description field that allows any text
URL (url): String representing the endpoint address for a service
Username (username): Field used during authentication to external system
Password (password): Field used during authentication to external system
Active (active): Defines if the Connection is active or not
Sequence (sequence): Order in which to process the connections

Event handler 408 then initiates a process to get a connection via connection manager 404, effectively registering. Registration may be done manually, getting connection information from 412 EGS and adding it to 404 Connection Manager. EGS 104 may also be able to register itself upon start, via an auto registration process. The connection information, such as the ID, is gathered from EGS 104. This effectively means that reactor 108 is connected to one or more EGS 104 and EGS 104 and reactor 108 are ready to communicate. Next, at 406, event handler 108/408 registers various configurations, essentially determining which rules event handler 108 wants to monitor for, and possibly react to (including, for example, threshold values required to create a reaction). Event Handler configurations may be registered with Reactor 108 and mapped 1:1 with the type of event it handles (the event it handles typically being a rule that has been violated).

Each event handler configuration may specify asset filter criteria, the “look back window” (how far back in time to look for the rule violation), the number of occurrences to consider before taking action, the total duration of the occurrences to consider before taking action, the action (reaction) to take, and reference a script to inject custom logic. Exemplary event handler configurations may include the following further fields:
Transaction (tranx—num): This field is the primary key and main identifier of an Event Handler
Description (description): This is a typical description field that allows any text
Active (active): Defines if the Event Handler is active or not
Sequence (sequence): Order in which to process Event Handlers
Login (actor_login): This field is used as the actor of any actions taken. If not defined it is assumed that the actor is the editor of the record.
Emails (emails): Comma separated list of email recipients
Last: This field allows the user to specify the look back window to consider events. It is split into two fields to allow the user to select different time units.
   (in_last_val): Numeric field
   (in_last_uom): Time unit.
      Hours—Time unit used to consider hours
      Days—Time unit used to consider the full date without using the time
      Weekdays—Time unit used to consider only weekdays
      Weeks—Used to specify weeks for look back window
Duration (duration): Numeric field holding the length of time a raised event needs to be in order to be considered for any further action
Occurrences (occurrence): Numeric field holding how many events need to occur in order to consider them for any further action
Status (status_code): Current status of the event handler. Active, Error, Inactive
Frequency (schd_freq): Rate at which Connections are poll for new events
Next Date (schd_next_date): Date and time at which an Event Handler is scheduled to run
Bootstrap Instance Id (instance_id): This field contains the id of the node that is responsible for running the process. Used for clustered environments.
Message (send_message): Yes/No drop down whether or not the Event Handler should try to create an Email Message. Duplicate logic applies. This option requires an email or a list of recipients.
Work Order (send_proposal): Yes/No drop down specifying whether or not to create a Work Order.
Customer Request (send_request): Yes/No drop down whether or not the Event Handler should try to create a Customer Request. Duplicate logic applies.
Skip Duplicates (skip_duplicates): Field that prevents creation of a new Customer Request if there is an existing open Request with the same Event Handler transaction id.
Script (doc_id): Look up field to the doc_id defined in the Document Profile screen. The document represents a script that is used to handle any custom action.
Email Template (doc_template_id): Look up field to the doc_id defined in the Document Profile screen. The document represents the email template to be used during creation of emails.
Event Id (rule_id): Id of an external analytic rule
Extra Description (long_desc): Typical long descriptions that allows any text entry

After 402, 458 and 406 system 100 is largely ready to begin polling and filtering energy management events.

The remaining components (such as 422, 428, 430, 442, 446, 450 and 454) may be logical sub-components of the Event Handler 404 and may substantially be contained therein or may be implemented physically separately.

At 410 Event Handler 408, which may be a controller or comprise components as described with respect to FIG. 3, given a Connection Manager and Event Handler configuration, interrogates EGS 104 for new events and pushes received events down the handler “pipeline”.

At 414 event handler 408 reacts to the event received via polling at 410, providing the event (or events, or stream, for example) to coarse filters 422. Coarse filters 422 provides a facility for chaining filters designed to exclude, or filter out, events from processing that clearly won't result in a useful action or, worse, simply generate system noise.

As shown in FIG. 4, exemplary coarse filters include Noisy Asset Filter 416 and Insufficient Data Filter 418. Such coarse filters 422 may provide coarse means to filter out events. In one embodiment coarse filters 422 may be the only steps of method 400 that may directly result in events being filtered out, the rest of the potential “filtering out” may refer the events for potential filtering to scripting engine 442 so that a user can handle or override potential filtering out. Coarse in the current context means there may be little in the way of deep inspection of the event payload with regard to logic, for example a grammar/“required field” filter that simply ensures the event “looks right”. A fine grained filter, for example, may evaluate a specific asset (equipment) checking to see if there is an existing Customer Request that may be a duplicate. Examination of the payload of an event, or the extent to which the filter descends into the fine details or the event, may determine classification as fine or coarse. It should be noted that “fine” filters are not shown in the figures but are within the scope of the invention.

In particular, noisy asset filter 416 provides a user definable, dynamic query used to identify candidate Assets for further processing. Assets not found are considered “noisy” and are thus excluded so as to prevent re-processing known issues. System 10 may provide the ability to save search criteria as a filter. In one example search criteria is saved that identifies assets dynamically. A search criteria could be saved that finds all assets in a particular building as opposed to identifying each asset individually in a list (static). Any asset that results from the search criteria saved is not considered a noisy asset and should not be excluded.

Insufficient Data Filter 418 provides a basic, “smoke test” or screening that ensures the inbound event contains enough contextual information to result in an action. This may include, for example, comparing the required fields for any of the actions that are enabled within the various generators—such that if the event does not have enough information to enable as least one generator to create one action then it may be filtered out. Further advanced insufficient data filtering may include: Events received that don't have duration, number of occurrences, asset is missing, asset is not defined in AiM, or no date specified.

Events that are filtered out may be sent to asset management subsystem 422/14. Alternatively, assets that are filtered out, for example via noisy asset filter 416, may be removed from further processing. This may end method 400, at least for the particular event being considered.

Alternatively, filtered Events are written to the Logger for debugging/analytical purposes. It should be noted that events (filtered or not) may be sent to one or more of logger 424 (which may be a simple text file) and activity log 438 (which may be a database), at substantially any step and from substantially any part of the system herein, depending on configuration and implementation choices. Activity Log may stores a detailed history of all actions initiated by the Reactor or any generator, errors encountered, and significant runtime messages. It is used to validate/debug Reactor behavior, aid in de-duplication logic and as a key data source for analysis.

Of course it is to be understood that various coarse filters may be chained together, in various sequences, or may be combined.

At 426 a decision to continue or not is made. Such decision may largely relate to whether an event has been filtered out or not. If method 400 is not to continue (at least for the currently contemplated energy management event) then method 400 ends at 424 where logging occurs. Method 400 may then wait for another event or process the next event in the stream.

If method 400 is continued from 426 then Occurrence Combiner 428 may be employed. An Event may contain more than one occurrence and, separately, the period(s) of time the occurrence lasted. Combiner 428 inspects the Event, tallies the number of occurrences, and the total duration of all occurrences. For example, an Event may indicate a cross heating and cooling problem with an air handler that occurred 4 times for 15 minutes each. In this scenario the Combiner is responsible for decoding the Event, identifying the 4 occurrences, and calculating the total duration of 60 minutes. Although combiner may filter out events, preferably it does not so that scripting engine may allow a user to take a different action, while allowing 444, 448 and 452 to filter out events.

Method 400 then continues at 432 where De-duper 432 operates. De-duper 432 is a component that identifies Events that, if processed, would result in a logically identical result if the target action is initiated (noting that the action being a duplicate may be the desired test for de-duper 432, though it may also be portions of the event itself). De-duplicating may involve searching in one or more other components (such as at 436 in searching customer request generator 430 and activity log 438) and by performing de-duplicating logic for each generator (or at least CRs and messaging generators) where each generator's de-duplicating logic may be different—for example a CR may be considered duplicate if it has the same asset and the same reactor_tranx_num while a Message may be considered duplicate if it has the same asset, event id, and date). If a duplicate is identified the event is marked as such for evaluation by downstream processes such as scripting engine 442. Although duplicate handling can vary for each implementation, in one example, duplicate handling varies by Action as follows:
If the Action is a Customer Request and the Event Handler configuration property “skip duplicates” is set to “Y” the Action is suppressed
If the Action is Message, the Action is always suppressed (so that people are not receiving duplicate messages)
Suppressed Events (which may be substantially similar to filtered out events, just that such occurs later in the overall filtering process) are always recorded within the Activity Log.

Method 400 may then continue to 440 where it is determined whether to run a script. This may largely involve determining whether custom scripts have been incorporated into the particular implementation and whether there is a script for the event being considered.

Events that are not already filtered out may continue to scripting engine 442 to see if there is a script that is to be applied to such event. Scripting engine 442 may perform various tasks, as described herein, with respect to the event, and then may cause method 400 to continue at 444/448/452 to determine whether further generators 460 (such as 208/210/212) should be employed to create one or more actions. Configurations of the system determine whether the optional steps in method 400 are taken, including the ability to specify the maximum number of actions that can be caused by one event, for example. The determinations at 444/448/452 may be determined by reference to event metadata that may be added or modified by the combiner, de-duper and/or scripting engine. Scripting engine may be placed as in FIG. 2 so that users of system 10 may amend/customize the possible rigid nature of generators, allowing generators to properly be set in ways that would be do with static provision of events to generators. For example, a user may want to create a work order to handle the failed damper—most work order fields may be “pushed” statically but some may need to be dynamic—say to look at where the event occurred so that a specific air handler tech can be assigned to the job. Doing so requires additional logic to be injected that can only be done effectively via script. Method 400 at 444/448/452 may substantially determining action generation. At this step method 400 has received events that have not been filtered out and reactor 108 is actioning them to enhance, improve and automate the user experience for those users of 10. Automatic actioning, of events that have already had various filters applied to them, reduces the noise that a user would experience and even prevents users from having to determine what events are not noise and creating the action. Operation at 444/448/452 may be substantially as described herein with respect to 208/210/212.

In one embodiment, each unique energy management event has a unique event handler, relating to one or more unique rules and each energy management event dataset comprises event data and event metadata. The metadata may comprise one or more flags for each generator, the flags being used by the generator to know whether the generator is to action the event, the flags being set by one or more of the combiner, de-duper or coarse/fine filters. Users may set and amend various parameters throughout the processing of the events via one or more screens that can be used to alter combiner, filters and de-duper settings, optionally in response to a review of one or more logs that indicate the results of performing the actioning, filtering, combining, de-duping in the past.

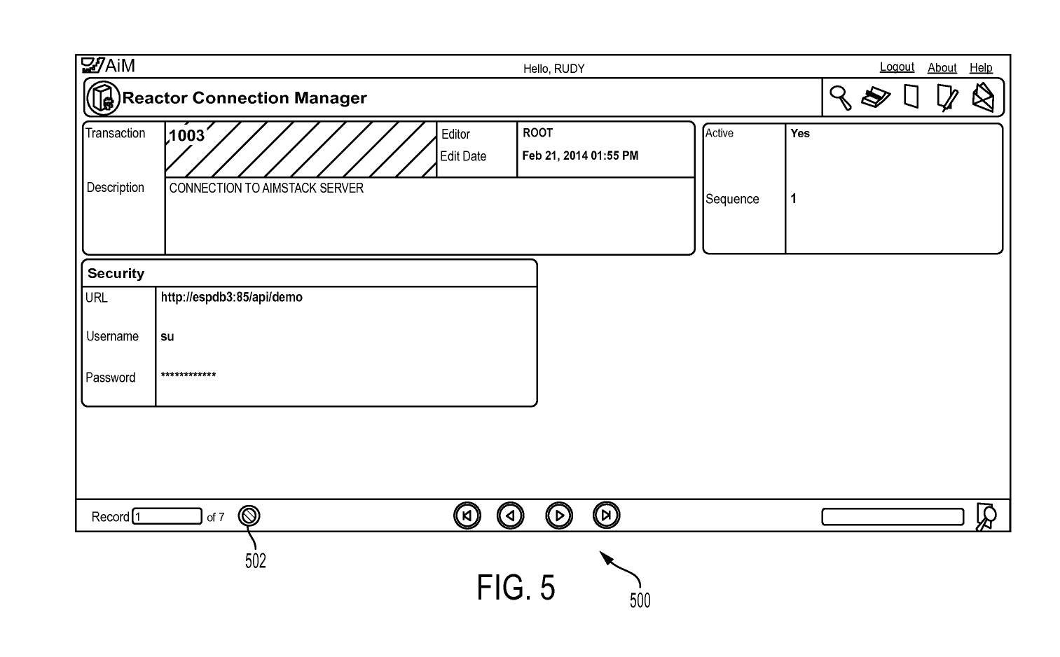

FIGS. 5-8 show screens for energy management event filtering according to an embodiment of the invention.

FIG. 5 is a screen 500 showing a user interface for accessing functionality of reactor connection manager 404.

This screen allows a user to define the connection configuration required to monitor the endpoint (for example EGS 104) for new events. Multiple connection profiles could be created since there maybe more than one instance of FMS 106 for a given deployment. Much of the functionality of reactor 108 underlying screen 500 may be standard for FMS 106 (such as AiM™) but screen 500 offers the users the option to test the connection upon save (selecting button 502, though the look and feel of button 502 may be substantially any button).

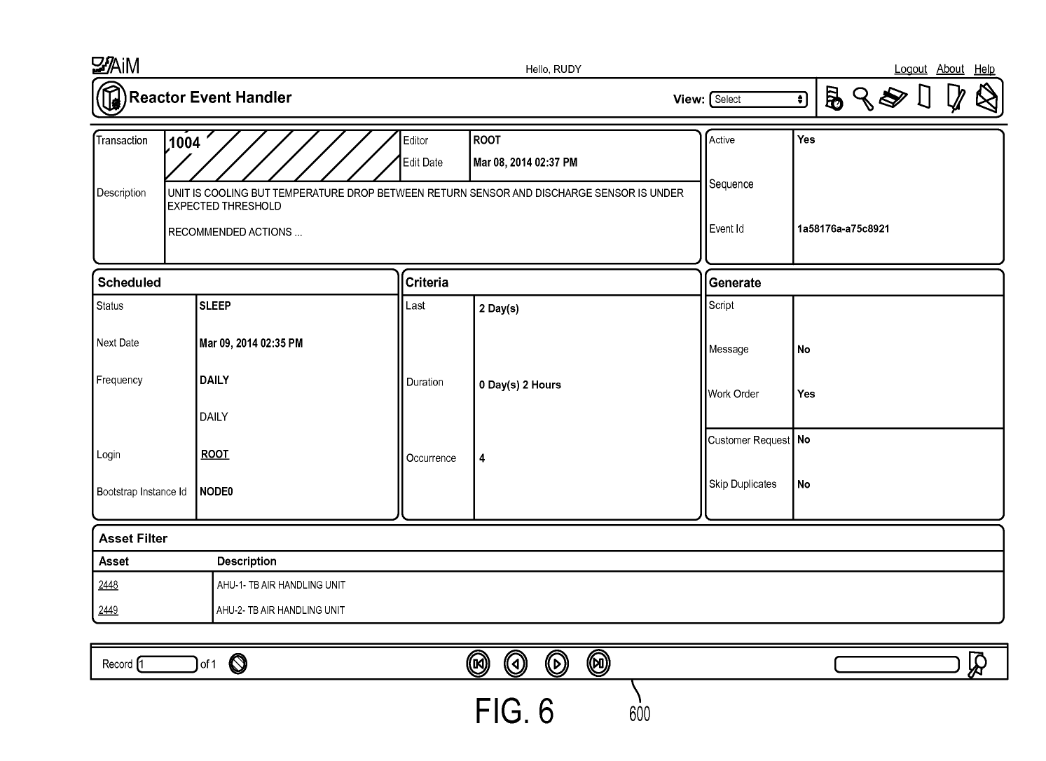

FIG. 6 is a screen 600 showing a user interface for accessing functionality of reactor event handler 408. Screen 600 provides the means to create a configuration for handling an external event. Users have the ability to select from three predefined event handling actions (which may be added to, deleted, or amended) and one option to customize the action via script. Events received are filtered out using the asset filter criteria, duration, and occurrences. It will be noted that many of the fields for an event handler configuration may be specified; of course other fields may be specified depending on the particular desires of the user and layout of screen 600.

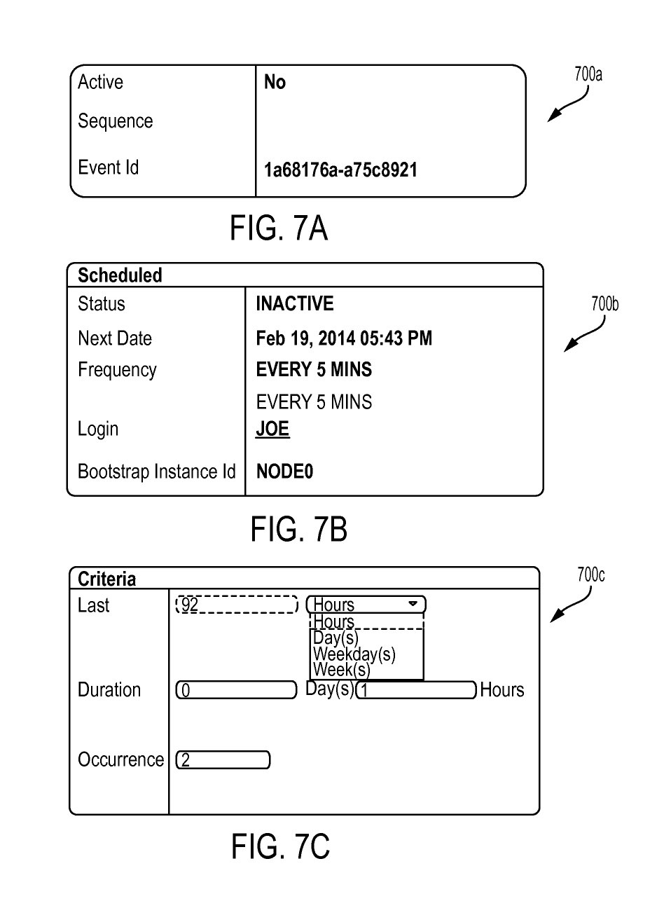

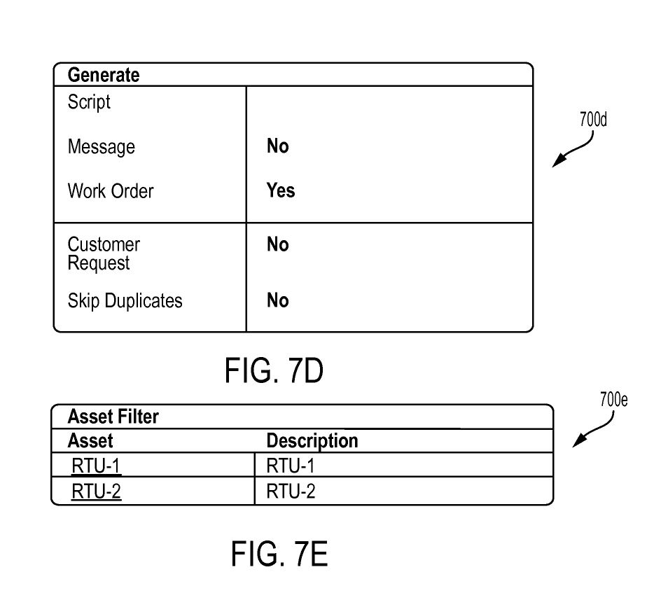

FIGS. 7a-e are screens 700a/700b/700c/700d/700e showing elements of screen 600.

FIG. 7a: The Event Id field specifies the id of the rule generating the event. This is an external id provided by the FMS 106 or EGS 104 (AiMStack server, and EGS,of AiM™, and FMS). The AiMStack rule specified is used to retrieve attributes that may be accessed during the generation process.

FIG. 7b: Provides a way to specify when, where, and how often to poll the Reactor Connections. The login field is used as the actor for any actions taken.

FIG. 7c: The criteria are used to filter out events requested and received from the Reactor Connection. The Last field is used during event request and it allows users to specify the look back window to consider events. Last (Hours): considers exactly X hours. Last (Days): considers X full days. Last (Weekday): consider only X weekdays. Only events that equal or exceed the duration and occurrence are considered for further actions.

FIG. 7d: Allows for creation of Work Order, Customer Request, or Email Messages based on the events that passed the criteria filter. Work Order and Customer Request are mutually exclusive, but any other combination is valid. The Message option requires an email or a list of shop person that can be configured in the Email Recipients view. The Skip Duplicates field prevents creation of a new Customer Request if there is an existing open Customer Request with the same reactor configuration ID. Custom actions are handled via script.

FIG. 7e: Used to allow only certain assets to be handled by current Reactor Event Notification (action of generators or generation). If the asset is not on the list then generators and actioning may be prevented.

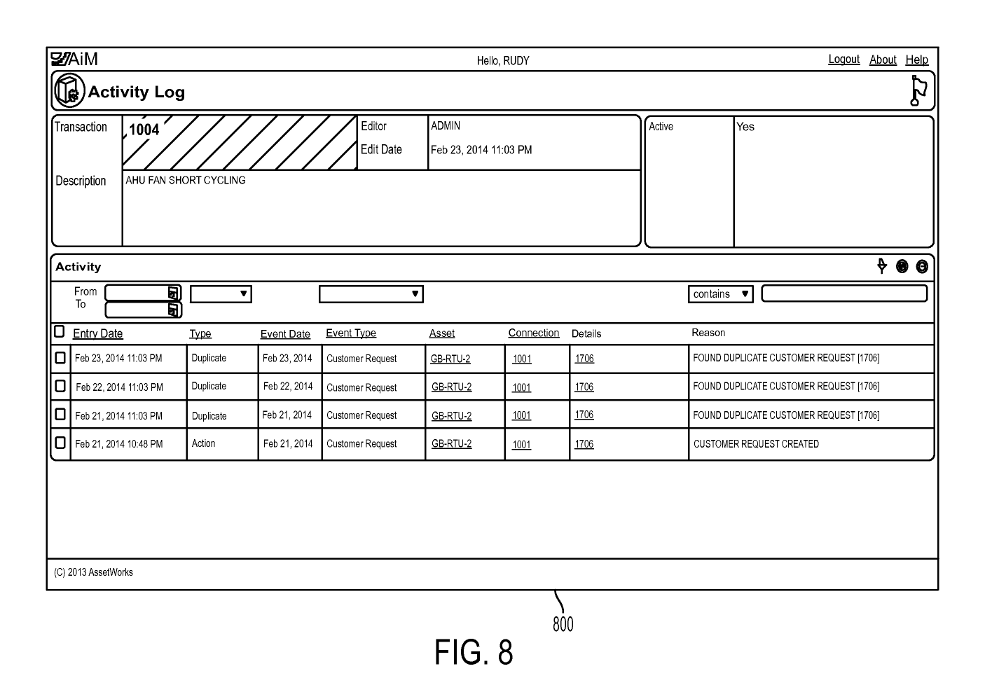

FIG. 8 is a screen 800 of a user interface for viewing and editing activity log data. Screen 800 provides users with access to a detailed history of actions, errors, and other messages captured during process execution. Entries can be filtered by Entry Date, Type, Event Type and Reason. The Activity Log may be used to fine tune criteria parameters, such as by adjusting duration or occurrences based on what events are found in the activity log, how those events or actions by generators worked for the user or FMS 106. Such adjustments may be done by users or via one or more algorithms within system 10.

As described herein, Activity Log Fields may include:
Entry Date: Date and Time when the entry was logged
Type: Type of message logged
   Action—Represents a successful execution that created a Work Order, Customer Request, or called a Script
   Duplicate—A Customer Request or Message was found to be a duplicate
   Error—An error was found during processing, no records were create nor emails sent
   Email—Used when an email is sent successfully
Event Date: This represents the date of the last event that occurred within the look back period.
Event Type: Type of event being generated. Work Order, Customer Request, Message, or Script
Asset: Asset Tag of the equipment involved in the event being processed.
Connection: Id of the connection being used to look for events
Details: Holds a link to record created or to the duplicate record found
Reason: Full description of the error encountered or list of email recipients

Computer-executable instructions for implementing the functionality and software, on a computer system could be provided separately from the computer system, for example, on a computer-readable medium (such as, for example, an optical disk, a hard disk, a USB drive or a media card—which may replace or complement storage 60 or RAM 48) or by making them available for downloading over a communications network, such as the Internet.

While the computer system is shown as a single physical computer, it will be appreciated that the computer system can include two or more physical computers in communication with each other. Accordingly, while the embodiment shows the various components of system 100, and TCC 20 residing on the same physical computer, those skilled in the art will appreciate that the components can reside on separate physical computers.

The above-described embodiments are intended to be examples of the present invention and alterations and modifications may be effected thereto, by those of skill in the art, without departing from the scope of the invention that is defined solely by the claims appended hereto.

What is claimed is:

1. A method for energy management event filtering comprising:
receiving, by an event handler controller of a facilities management system, an unfiltered stream of energy management events from an energy management system, where each energy management event relates to violation of a unique rule in the energy management system;
determining, for each energy management event, whether there is an event handler configuration for the rule relating to the energy management event;
if there is the event handler configuration for the rule relating to the energy management event then:
applying one or more coarse event filters in the event handler configuration to the energy management event to determine whether to filter out the energy management event;
combining the occurrences of the energy management event to determine whether to filter out the energy management event;
de-duplicating the energy management event to determine whether to filter out the energy management event; and
actioning, by a generator, the energy management event if it has not been filtered out.

2. The method of claim 1 comprising ignoring or filtering out the energy management event if there is no event handler configuration.

3. The method of claim 1 comprising ignoring or filtering out the energy management event if the event's asset is on a list of assets to filter out.

4. The method of claim 3 comprising dynamically establishing the list of assets by applying criteria to a list of total available assets.

5. The method of claim 1 wherein the combining comprises assembling the number occurrences of an energy management event and the duration of each occurrence to determine a total impact to make the determining.

6. The method of claim 1 further comprising providing the energy management event to a scripting engine to apply a script if a script is specified for the event.

7. The method of claim 6 wherein the scripting engine receives all events except those that are filtered out by the applying.

8. The method of claim 1 wherein the event comprises event data and event metadata, the event metadata comprising a flag for each generator, and wherein the combining and de-duplicating set the metadata flag.

9. The method of claim 1 wherein the de-duplicating comprises discarding duplicate events that would lead to duplicate actioning or steps by one or more generators.

10. The method of claim 1 wherein the actioning comprises one or more of displaying the energy management event, sending the energy management event for processing in a script, sending the energy management event in a message, creating a work order from the energy management event, or creating a customer request from the energy management event.

11. A system for energy management event filtering in a facilities management system comprising a generator and an event handler controller; the event handler controller having a processor for executing instructions stored in a computer readable medium to:
receive an unfiltered stream of energy management events from an energy management system, where each energy management event relates to violation of a unique rule in the energy management system;
determine, for each energy management event, whether there is an event handler configuration for the rule relating to the energy management event;
if there is the event handler configuration for the rule relating to the energy management event then:
apply at least one coarse event filter in the event handler configuration to the energy management event to determine whether to filter out the energy management event;
combine the occurrences of the energy management event to determine whether to filter out the energy management event;
de-duplicate the energy management event to determine whether to filter out the energy management event; and
actioning, by the generator, the energy management event if it has not been filtered out.

12. The system of claim 11, wherein the instructions further comprise an instruction to ignore or filter out the energy management event if there is no event handler configuration.

13. The system of claim 11, wherein the instructions further comprise an instruction to ignore or filter out the energy management event if the event's asset is on a list of assets to filter out.

14. The system of claim 13, wherein the instructions further comprise an instruction to dynamically establish the list of assets by applying criteria to a list of total available assets.

15. The system of claim 11 wherein the instruction to combine comprises assembling the number occurrences of an energy management event and the duration of each occurrence to determine a total impact to make the determining.

16. The system of claim 11, further comprising a scripting engine and wherein the instructions further comprise an instruction to provide the energy management event to the scripting engine to apply a script if a script is specified for the event.

17. The system of claim 16 wherein the scripting engine receives all events except those that are filtered out by the applying.

18. The system of claim 11 wherein the event comprises event data and event metadata, the event metadata comprising a flag for each generator, and wherein the combining and de-duplicating set the metadata flag.

19. The system of claim 11 wherein the de-duplicating comprises discarding duplicate events that would lead to duplicate actioning or steps by one or more generators.

20. The system of claim 11 wherein the actioning comprises one or more of displaying the energy management event, sending the energy management event for processing in a script, sending the energy management event in a message, creating a work order from the energy management event, or creating a customer request from the energy management event.
